(19) United States
(12) Patent Application Publication
(10) Pub. No.: US 2018/0178618 A1
(43) Pub. Date: Jun. 28, 2018

(54) AIRFLOW CONTROL SYSTEM FOR A COOL BOX AND A CAB OF A WORK VEHICLE

(71) Applicant: CNH Industrial America LLC, New Holland, PA (US)

(72) Inventors: Doriano Ferri, Brussels (BE); Tom Thierry Marc Peter Arsène Devriese, Veldegem (BE); John Edward Burnham, Batavia, IL (US)

(73) Assignee: CNH Industrial America LLC

(21) Appl. No.: 15/391,196

(22) Filed: Dec. 27, 2016

(51) Int. Cl. B60H 1/00

(52) U.S. Cl. CPC B60H 1/00378; B60H 1/00014; B60H 1/00864; B60H 1/00021

(57) ABSTRACT

An airflow control system of a work vehicle includes a cool box input flow passage configured to only receive a cooling system output airflow and to provide only the cooling system output airflow to the cool box. In addition, the airflow control system includes a cool box input valve fluidly coupled to the cool box input flow passage. The cool box input valve is configured to control the cooling system output airflow through the cool box input flow passage. The airflow control system also includes a controller communicatively coupled to the cool box input valve. The controller is configured to instruct the cool box input valve to selectively transition to an open position, a closed position, and a position between the open and closed positions to control a temperature within an interior of the cool box.

### BACKGROUND

The present disclosure relates generally to an airflow control system for a cool box and a cab of a work vehicle.

Certain work vehicles (e.g., tractors, harvesters, skid steers, etc.) include a heating, ventilation, and air condition (HVAC) system configured to provide an airflow into a cab of the work vehicle. HVAC systems typically include a cooling system to cool the airflow into the cab and a heating system configured to heat the airflow into the cab. For example, the cooling system may be activated in warmer months to reduce the air temperature within the cab, and the heating system may be activated in cooler months to increase the air temperature within the cab. In addition, certain work vehicles include a cool box configured to cool items (e.g., drinks, food, etc.) within the cool box. The cool box may receive chilled air from the cooling system of the HVAC system. However, when an operator activates the cooling system to cool the items within the cool box, the cab of the work vehicle may receive the chilled air from the cooling system. Flowing chilled air into the cab of the work vehicle while the cool box is activated may be undesirable (e.g., while operating the work vehicle during cooler months).

### BRIEF DESCRIPTION

In one embodiment, an airflow control system of a work vehicle includes a cooling system output flow passage configured to receive a cooling system output airflow from a cooling system and to direct the cooling system output airflow toward a cab of the work vehicle. The airflow control system also includes a cool box input flow passage having a first end fluidly coupled to the cooling system output flow passage and a second end directly fluidly coupled to a cool box. The cool box input flow passage is configured to only receive the cooling system output airflow and to provide only the cooling system output airflow to the cool box. In addition, the airflow control system includes a cool box input valve fluidly coupled to the cool box input flow passage between the first end and the second end. The cool box input valve is configured to control the cooling system output airflow through the cool box input flow passage. The airflow control system also includes a controller communicatively coupled to the cool box input valve. The controller is configured to instruct the cool box input valve to selectively transition to an open position, a closed position, and a position between the open and closed positions to control a temperature within an interior of the cool box.

In another embodiment, a heating, ventilation, and air conditioning (HVAC) system of a work vehicle includes a cool box configured to storage objects and a cooling system configured to output a cooling system output airflow. The HVAC system also includes a heating system configured to receive the cooling system output airflow and to generate a heating system output airflow. In addition, the HVAC system includes a cooling system output flow passage extending between the cooling system and the heating system. The cooling system output flow passage is configured to receive the cooling system output airflow and to provide the cooling system output airflow to the heating system. The HVAC system also includes a heating system output flow passage configured to receive the heating system output airflow from the heating system and to direct the heating system output airflow toward a cab of the work vehicle. Furthermore, the HVAC system includes a cool box input flow passage configured to receive a cool box input airflow from the cooling system and to provide the cool box input airflow to the cool box. The HVAC system also includes a controller communicatively coupled to the cooling system and to the heating system. The controller is configured to control a capacity of the heating system based at least in part on a capacity of the cooling system at least while the cooling system is in operation to provide the cool box input airflow to the cool box.

In a further embodiment, an airflow control system of a work vehicle includes a cooling system output flow passage configured to receive a cooling system output airflow from a cooling system and to direct the cooling system output airflow toward a cab of the work vehicle. The airflow control system also includes a cooling system output valve configured to control the cooling system output airflow through the cooling system output flow passage. In addition, the airflow control system includes a cooling system bypass flow passage configured to receive a cooling system bypass airflow from a blower and to direct the cooling system bypass airflow toward the cab of the work vehicle while bypassing the cooling system. The airflow control system also includes a cooling system bypass valve configured to control the cooling system bypass airflow through the cooling system bypass flow passage. Furthermore, the airflow control system includes a cool box input flow passage configured to receive a cool box input airflow from the cooling system and to provide the cool box input airflow to a cool box.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may include an airflow control system for a cool box and a cab of the work vehicle;

FIG. 2 is a schematic diagram of an embodiment of an HVAC system having an airflow control system that may be employed within the work vehicle of FIG. 1;

FIG. 3 is a schematic diagram of an embodiment of a valve assembly that may be employed within the airflow control system of FIG. 2; and

FIG. 4 is a flow diagram of an embodiment of a method for controlling airflow to the cool box and to the cab of the work vehicle.

### DETAILED DESCRIPTION

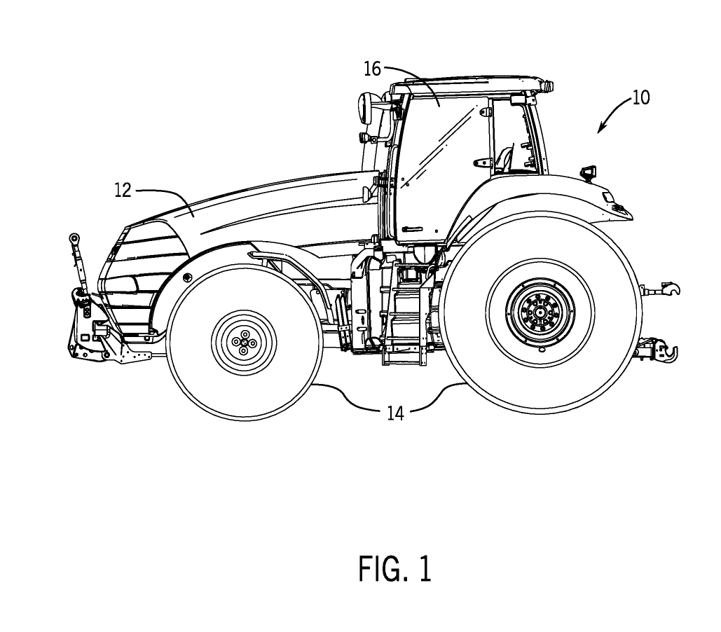

Turn now to the drawings, FIG. 1 is a side view of an embodiment of a work vehicle 10 that may include an airflow control system. In the illustrated embodiment, the work vehicle 10 includes a body 12 configured to house an engine, a transmission, other systems of the work vehicle 10, or a combination thereof. In addition, the work vehicle 10 includes wheels 14 that are driven by the engine and transmission, thereby driving the work vehicle 10 through a field, along a road, or along any other suitable surface. In the illustrated embodiment, the work vehicle 10 includes a cab 16 configured to house an operator. As discussed in detail below, the work vehicle may include a heating, ventilation, and air conditioning (HVAC) system configured to control an air temperature within the cab. In addition, the work vehicle may include a cool box configured to cool items (e.g., drinks, food, etc.) within the cool box. An airflow control system may provide chilled air from a cooling system of the HVAC system to the cool box, thereby cooling the items within the cool box.

In certain embodiments, the airflow control system may include a cooling system bypass flow passage that receives an airflow from a blower of the HVAC system and directs the airflow toward the cab of the work vehicle while bypassing the cooling system. Accordingly, the cool box may receive chilled air from the cooling system while the cab receives warmer air (e.g., air from the external environment, air from a heating system, etc.), thereby facilitating operator comfort (e.g., during colder months). In further embodiments, the cooling system bypass flow passage may be omitted, and the airflow from the blower may flow to the cab through the cooling system and the heating system. In such embodiments, the airflow control system may include a controller configured to increase a capacity of the heating system while the cooling system is in operation to provide the cool box with chilled air. Accordingly, the heating system may compensate for the chilled air received from the cooling system, thereby facilitating operator comfort (e.g., during colder months). While the illustrated work vehicle 10 is a tractor, it should be appreciated that the airflow control system described herein may be employed within any suitable work vehicle, such as a harvester, a sprayer, or a skid steer, among others.

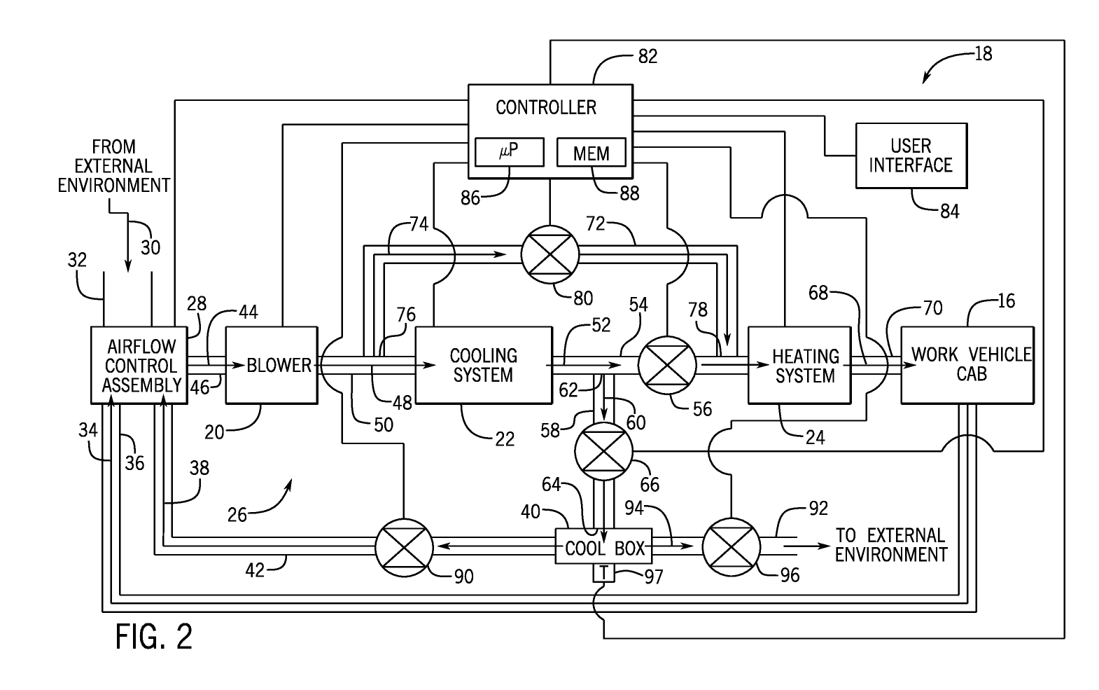

FIG. 2 is a schematic diagram of an embodiment of an HVAC system 18 that may be employed within the work vehicle of FIG. 1. In the illustrated embodiment, the HVAC system 18 includes a blower 20, a cooling system 22, a heating system 24, and an airflow control system 26. The airflow control system 26 includes an airflow control assembly 28 configured to control mixing of air from an environment external to the cab with air recirculated from the cab. As illustrated, the airflow control assembly 28 is configured to receive an airflow 30 (e.g., system input airflow) from the environment external to the cab 16 via a system input flow passage 32, and the airflow control assembly 28 is configured to receive an airflow 34 (e.g., cab output airflow) from an interior of the cab 16 via a cab output flow passage 36. In certain embodiments, the airflow control assembly 28 is also configured to receive an airflow 38 (e.g., cool box output airflow) from a cool box 40 via a first cool box output flow passage 42. The airflow control assembly 28 is configured to control mixing of the external air with the recirculated air (e.g., from the cab 16 and/or from the cool box 40) and to output an airflow 44 (e.g., blower input airflow) to the blower 20 via a blower input flow passage 46.

The blower 20 is configured to receive the airflow 44 from the airflow control assembly 28 and to output an airflow 48 (e.g., blower output airflow, cooling system input airflow) via a cooling system input flow passage 50. In addition, the cooling system 22 is configured to receive the airflow 48 from the blower 20 and to output a chilled airflow 52 (e.g., cooling system output airflow) via a cooling system output flow passage 54. The cooling system output flow passage 54 is configured to receive the airflow 52 from the cooling system 22 and to direct the airflow toward the cab 16 of the work vehicle. As used herein, “toward” refers to directing an airflow along at least a portion of a flow path that ultimately reaches a target (e.g., the cab of the work vehicle). Accordingly, an airflow toward a target does not necessarily flow in the direction of the target (e.g., based on the configuration of the flow path).

The airflow through the cooling system 22 may flow through an evaporator of a refrigeration system, thereby producing the chilled airflow 52, which has a lower temperature than the input airflow 48. For example, the refrigeration system may include an evaporator, a compressor, an expansion valve, and a condenser. The airflow may flow through the evaporator to reduce the temperature of the airflow. While a refrigeration system is described above, it should be appreciated that the cooling system may utilize any suitable device/system to reduce the temperature of the airflow (e.g., a Peltier device, etc.).

In the illustrated embodiment, the airflow control system 26 includes a cooling system output valve 56 configured to control (e.g., selectively block) the airflow 52 through the cooling system output flow passage 54. Accordingly, while the cooling system output valve 56 is open, the chilled airflow 52 flows through the cooling system output flow passage to the cab 16, and while the cooling system output valve 56 is closed, the chilled airflow 52 to the cab 16 is blocked. For example, if a chilled airflow to the cab is desired (e.g., during warmer months), the cooling system output valve 56 may be opened. And, if a chilled airflow to the cab is not desired (e.g., during colder months), the cooling system output valve 56 may be closed.

Furthermore, the airflow control system 26 includes a cool box input flow passage 58 configured to receive an airflow 60 (e.g., cool box input airflow, cooling system output airflow) from the cooling system 22 and to provide the airflow to the cool box 40. In the illustrated embodiment, a first end 62 of the cool box input flow passage 58 is fluidly coupled to the cooling system output flow passage 54 upstream of the cooling system output valve 56, and a second end 64 of the cool box input flow passage 58 is fluidly coupled (e.g., directly fluidly coupled) to the cool box 40. Accordingly, the chilled airflow from the cooling system may flow to the cool box. In the illustrated embodiment, the cool box input flow passage is configured to only receive the airflow 60 and to provide only the airflow 60 to the cool box. Accordingly, the cool box input flow passage does not receive or provide any other airflow to the cool box (e.g., airflow output from the heating system). In the illustrated embodiment, a cool box input valve 66 is fluidly coupled to the cool box input flow passage 58 between the first end 62 and the second end 64. The cool box input valve 66 is configured to control (e.g., selectively block) the airflow 60 through the cool box input flow passage. Accordingly, while the cool box input valve 66 is open, the chilled airflow flows through the cool box input flow passage to the cool box 40, and while the cool box input valve 66 is closed, the chilled airflow to the cool box 40 is blocked. For example, if a chilled airflow to the cool box is desired (e.g., to cool items within the cool box), the cool box input valve 66 may be opened. And, if a chilled airflow to the cool box is not desired (e.g., while the cool box is empty), the cool box input valve 66 may be closed. While the first end 62 of the cool box input flow passage 58 is fluidly coupled to the cooling system output flow passage 54 in the illustrated embodiment, it should be appreciated that in alternative embodiments, the first end of the cool box input flow passage may be fluidly coupled to the cooling system directly or to another flow passage that receives the chilled airflow from the cooling system. In addition, while the cool box input valve 66 is fluidly coupled to the cool box input flow passage 58 in the illustrated embodiments, it should be appreciated that in alternative embodiments, the cool box input valve may be omitted. In such embodiments, air may continuously flow to the cool box while the blower is activated.

In the illustrated embodiment, the cooling system output flow passage 54 is fluidly coupled to the heating system 24. Accordingly, the cooling system output flow passage 54 is configured to receive chilled air 52 from the cooling system 22 and to provide the chilled air 52 to the heating system 24. The heating system may include a heater core, which receives hot coolant from the engine of the work vehicle. As the air flows through the heater core, the temperature of the air increases, thereby establishing a heated airflow 68 (e.g., heating system output airflow). The heated airflow 68 flows through a heating system output flow passage 70 to the cab 16 of the work vehicle. While a heater core is described above, it should be appreciated that the heating system may include any other suitable heating system/device to heat the airflow into the cab (e.g., an electric heater, etc.). Furthermore, the heating system 24 may be selectively deactivated, such that the airflow from the cooling system may flow through the heating system without being heated. Accordingly, the chilled air from the cooling system may remain cool as the airflow passes through the heating system. In certain embodiments, the heating system may be omitted, or the heating system may flow air into the cab of the work vehicle independently of the cooling system (e.g., the heating system and the cooling system may flow air into the cab via independent flow passages).

The airflow control system 26 also includes a cooling system bypass flow passage 72 configured to receive the airflow 48 from the blower 20 and to direct an airflow 74 (e.g., blower output airflow, cooling system bypass airflow) toward the cab 16 of the work vehicle while bypassing the cooling system 22. In the illustrated embodiment, a first end 76 of the cooling system bypass flow passage 72 is fluidly coupled to the cooling system input flow passage 50, and a second end 78 of the cooling system bypass flow passage 72 is fluidly coupled to the cooling system output flow passage 54 downstream from the cooling system output valve 56. Accordingly, the cooling system bypass flow passage 72 is configured to flow air from the blower 20 to the heating system 24 while bypassing the cooling system 22. In certain embodiments, the first end of the cooling system bypass flow passage may be directly fluidly coupled to the blower or to another flow passage that receives the airflow from the blower. Furthermore, in certain embodiments, the second end of the cooling system bypass flow passage may be directly fluidly coupled to the heating system or to another flow passage that provides an airflow to the heating system. In embodiments in which the heating system is omitted or the heating system and the cooling system flow air into the cab via independent flow passages, the second end of the cooling system bypass flow passage may be directly fluidly coupled to the cab or to another flow passage that provides an airflow to the cab.

In the illustrated embodiment, the airflow control system 26 includes a cooling system bypass valve 80 configured to control (e.g., selectively block) the airflow 74 through the cooling system bypass flow passage 72. Accordingly, while the cooling system bypass valve 80 is open, the airflow 74 flows through the cooling system bypass flow passage 72 to the cab 16, and while the cooling system bypass valve 80 is closed, the airflow 74 to the cab 16 is blocked. For example, if a chilled airflow to the cab is desired (e.g., during warmer months), the cooling system 22 may be activated, the heating system 24 may be deactivated, the cooling system output valve 56 may be opened, and the cooling system bypass valve 80 may be closed. And, if a heated airflow to the cab is desired, the heating system 24 may be activated, the cooling system output valve 56 may be closed, and the cooling system bypass valve 80 may be opened.

In the illustrated embodiment, the HVAC system 18 (e.g., the airflow control system 26 of the HVAC system 18) includes a controller 82 communicatively coupled to the blower 20, the cooling system 22, the heating system 24, the airflow control assembly 28, the cooling system output valve 56, the cool box input valve 66, and the cooling system bypass valve 80. The controller 82 may be configured to control the valves of the airflow control system, thereby controlling the airflow through the HVAC system. In addition, the controller 82 may be configured to control the airflow output by the blower, and/or the capacity of the cooling system and/or the heating system, thereby controlling the airflow (e.g., a temperature of the airflow, a flow rate of the airflow, etc.) into the cab. In the illustrated embodiment, the controller 82 is communicatively coupled to a user interface 84. The user interface 84 may be located within the cab of the work vehicle and configured to receive input from the operator, such as input for controlling the airflow control system, the blower, the cooling system, the heating system, or a combination thereof.

In certain embodiments, the controller 82 is an electronic controller having electrical circuitry configured to process data from certain components of the HVAC system 18, such as the user interface 84. In the illustrated embodiment, the controller 82 include a processor, such as the illustrated microprocessor 86, and a memory device 88. The controller 82 may also include one or more storage devices and/or other suitable components. The processor 86 may be used to execute software, such as software for controlling the HVAC system, and so forth. Moreover, the processor 86 may include multiple microprocessors, one or more “general-purpose” microprocessors, one or more special-purpose microprocessors, and/or one or more application specific integrated circuits (ASICS), or some combination thereof. For example, the processor 86 may include one or more reduced instruction set (RISC) processors.

The memory device 88 may include a volatile memory, such as random access memory (RAM), and/or a nonvolatile memory, such as read-only memory (ROM). The memory device 88 may store a variety of information and may be used for various purposes. For example, the memory device 88 may store processor-executable instructions (e.g., firmware or software) for the processor 86 to execute, such as instructions for controlling the HVAC system, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the HVAC, etc.), and any other suitable data.

The controller 82 is configured to control the valves of the airflow control system 26, thereby controlling airflow through the HVAC system 18. In addition, the controller 82 is configured to control the blower 20, the cooling system 22, and the heating system 24 to provide a desired airflow (e.g., air flow rate, air temperature, etc.) to the cab 16 of the work vehicle. For example, to activate the cool box and to provide chilled air to the cab 16 of the work vehicle (e.g., in response to input from the user interface 84), the controller 82 may activate the cooling system 22 and deactivate the heating system 24. In addition, the controller 82 may instruct the cooling system output valve 56 to open, the cool box input valve 66 to open, and the cooling system bypass valve 80 to close. As a result, the chilled air from the cooling system 22 may flow toward the cab 16 of the work vehicle and to the cool box 40, thereby reducing the air temperature within the cab 16 and the cool box 40.

Furthermore, to activate the cool box 40 and to provide heated air to the cab 16 of the work vehicle, the controller may activate the cooling system 22 and the heating system 24. In addition, the controller 82 may instruct the cooling system output valve 56 to close, the cool box input valve 66 to open, and the cooling system bypass valve 80 to open. With the cooling system output valve 56 closed, chilled airflow from the cooling system 22 to the cab 16 is blocked, and with the cooling system bypass valve 80 open, the airflow from the blower bypasses the cooling system 22 and flows to the heating system 24. As a result, heated air from the heating system 24 may flow toward the cab 16 of the work vehicle, thereby increasing the air temperature within the cab 16. In addition, with the cooling system output valve 56 closed and the cool box input valve 66 open, chilled air from the cooling system 22 flows toward the cool box 40, thereby reducing the air temperature within the cool box 40. Furthermore, if an ambient airflow into the cab 16 is desired, the controller may deactivate the heating system 24, and the airflow from the blower, which bypasses the cooling system via the cooling system bypass flow passage, may pass through the heating system without being heated. In addition, if no airflow to the cab is desired, the controller may instruct the cooling system bypass valve 80 to close, thereby blocking airflow through the cooling system bypass flow passage to the cab. Because the cooling system bypass flow passage bypasses the cooling system, a heated airflow, an ambient temperature airflow, or no airflow may be provided to the cab while the cool box receives chilled air from the cooling system.

To deactivate the cool box 40 and to provide chilled air to the cab 16, the controller may activate the cooling system 22 and deactivate the heating system 24. In addition, the controller may instruct the cooling system output valve 56 to open, the cool box input valve 66 to close, and the cooling system bypass valve 80 to close. With the cooling system output valve 56 open, the chilled airflow from the cooling system 22 flows toward the cab 16 of the work vehicle, thereby reducing the air temperature within the cab 16. In addition, because the cool box input valve 66 is closed, the flow of chilled air to the cool box 40 is blocked.

Furthermore, to deactivate the cool box 40 and to provide heated air to the cab 16, the controller may deactivate the cooling system 22 and activate the heating system 24. In addition, the controller may instruct the cooling system output valve 56 to close, the cool box input valve 66 to close, and the cooling system bypass valve 80 to open. With the cooling system bypass valve 80 open, the airflow from the blower may bypass the cooling system and flow through the heating system to the cab 16, thereby providing the cab with a heated airflow. In addition, because the cool box input valve 66 is closed, the flow of air into the cool box 40 is blocked. To provide an ambient temperature airflow to the cab 16, the heating system 24 may be deactivated. And, to block airflow to the cab 16, the controller may instruct the cooling system bypass valve 80 to close. In certain embodiments, heated or ambient temperature air may be provided to the cab 16 by opening the cooling system output valve 56 and closing the cooling system bypass valve 80, or by opening the cooling system output valve 56 and opening the cooling system bypass valve 80. Because the cooling system 22 is deactivated, the airflow from the blower may flow through the cooling system 22 and/or bypass the cooling system 22 as the air flows toward the cab 16.

In addition, the controller 82 is configured to adjust the airflow output from the blower 20 (e.g., a pressure of the airflow, a flow rate of the airflow, etc.) based at least in part on whether airflow to the cab 16 and/or to the cool box 40 is desired. For example, while the cool box 40 is deactivated (e.g., while the cool box input valve 66 is closed) and airflow to the cab 16 is desired, the controller 82 may determine the minimum blower output sufficient to provide the desired airflow to the cab 16 (e.g., based on input from the user interface 84). The controller 82 may then instruct the blower 20 to provide the determined airflow output. In addition, while the cool box 40 is activated (e.g., while the cool box input valve 66 is open) and no airflow to the cab 16 is desired (e.g., the cooling system output valve 56 and the cooling system bypass valve 80 are closed), the controller 82 may determine the minimum blower output sufficient to provide the desired airflow to the cool box 40 (e.g., based on input from the user interface 84). The controller 82 may then instruct the blower 20 to provide the determined airflow output. Furthermore, while the cool box 40 is activated and airflow to the cab 16 is desired, the controller 82 may determine the minimum blower output sufficient to provide the desired airflow to the cab 16 and to the cool box 40 (e.g., based on input from the user interface 84). The controller 82 may then instruct the blower 20 to provide the determined airflow output.

In addition, the controller 82 is configured to adjust the capacity of the cooling system 22 based at least in part on whether chilled airflow to the cab 16 and/or to the cool box 40 is desired. For example, while the cool box 40 is deactivated (e.g., while the cool box input valve 66 is closed) and chilled airflow to the cab 16 is desired, the controller 82 may determine the minimum cooling system capacity sufficient to provide airflow of a desired temperature to the cab 16 (e.g., based on input from the user interface 84). The controller 82 may then instruct the cooling system 22 to operate at the determined capacity. In addition, while the cool box 40 is activated (e.g., while the cool box input valve 66 is open) and no chilled airflow to the cab 16 is desired (e.g., while the cooling system output valve 56 is closed), the controller 82 may determine the minimum cooling system capacity sufficient to provide airflow at a desired temperature to the cool box 40 (e.g., based on input from the user interface 84). The controller 82 may then instruct the cooling system 22 to operate at the determined capacity. Furthermore, while the cool box 40 is activated and chilled airflow to the cab 16 is desired, the controller 82 may determine the minimum cooling system capacity sufficient to provide airflow at a desired temperature to the cab 16 and to the cool box 40 (e.g., based on input from the user interface 84). The controller 82 may then instruct the cooling system 22 to operate at the determined capacity.

In the illustrated embodiments, the airflow control system 26 includes a first cool box output valve 90 configured to control (e.g., selectively block) the airflow through the first cool box output flow passage 42. In addition, the airflow control system 26 includes a second cool box output flow passage 92 configured to receive an airflow 94 (e.g., second cool box output airflow) from the cool box 40 and to direct the airflow to the external environment. In the illustrated embodiment, a second cool box output valve 96 is fluidly coupled to the second cool box output flow passage 92 and configured to control (e.g., selectively block) the airflow 94 from the cool box 40 to the external environment. The first cool box output valve 90 and the second cool box output valve 96 are communicatively coupled to the controller 82. The controller 82 is configured to instruct the first cool box output valve 90 to open and the second cool box output valve 96 to close to recirculate the air from the cool box to the blower 20 (e.g., while chilled airflow to the cab 16 is desired). In addition, the controller 82 is configured to instruct the first cool box output valve 90 to close and the second cool box output valve 96 to open to direct the air from the cool box to the external environment (e.g., while chilled airflow to the cab 16 is not desired). The controller 82 may also be configured to instruct the first cool box output valve 90 and the second cool box output valve 96 to open to recirculate a portion of the air from the cool box 40. In certain embodiments, the first cool box output flow passage or the second cool box output flow passage, and at least one of the cool box output valves, may be omitted.

In certain embodiments, the cooling system bypass flow passage and the cooling system bypass valve may be omitted. In such embodiments, the cooling system output airflow 52 may flow into the heating system 24. Accordingly, while the cool box is activated (e.g., while the cool box input valve 66 is open) and a heated airflow to the cab 16 is desired, the controller 82 may activate the cooling system 22 and the heating system 24. In addition, the controller 82 may control a capacity of the heating system 24 based at least in part on the capacity of the cooling system 22. For example, the controller 82 may instruct the heating system 24 to increase capacity to compensate for the chilled air output by the cooling system 22, thereby providing an airflow having a desired temperature to the work vehicle cab. By way of example, while the cool box is deactivated (e.g., while the cool box input valve 66 is closed), the operator may instruct the heating system 24 to operate at a target capacity (e.g., via the user interface 84). The operator may then instruct the cool box to activate (e.g., via the user interface 84). Upon receiving instructions to activate the cool box, the controller 82 may instruct the cool box input valve 66 to open and instruct the cooling system 22 to activate (e.g., at a target capacity based on a desired temperature of the cool box). The controller 82 may then instruct the heating system 24 to increase capacity based at least in part on the capacity of the cooling system 22, such that the temperature of the airflow output by the heating system 24 substantially equals the temperature of the airflow output by the heating system before activation of the cool box. Accordingly, occupant comfort may be maintained.

While each of the valves disclosed above is configured to selectively block flow through a respective flow passage, it should be appreciated that in certain embodiments, one or more of the valves may be configured to control flow through the respective flow passage(s). For example, in certain embodiments, one or more valves may be proportional control valve(s) configured to control the pressure and/or the flow rate through the respective passage(s) based on a position of the valve(s) (e.g., fully open, partially open, or fully closed). By way of example, in certain embodiments, the cool box input valve may control the flow of chilled air into the cool box based at least in part on a target temperature of the cool box (e.g., based on user input). In such embodiments, the controller may instruct the cool box input valve to enable a sufficient flow of chilled air into the cool box to establish the target temperature within an interior of the cool box (e.g., based on feedback, such as a signal, from a temperature sensor 97). By way of example, the controller may control the airflow output from the blower, the capacity of the cooling system, the position of the cool box input valve, or a combination thereof, to establish a target/desired temperature within the cool box and to provide an airflow into the work vehicle cab having a target/desire temperature.

Furthermore, in certain embodiments that include the cooling system bypass flow passage, the controller may control the cooling system output valve and/or the cooling system bypass valve (e.g., by instructing both valves to partially open, by instructing one valve to partially open and the other valve to fully open, etc.) to establish a combined airflow from the cooling system bypass flow passage and the cooling system output flow passage, which flows toward the work vehicle cab. By controlling the ratio of the airflows from the cooling system bypass flow passage and the cooling system output flow passage, the controller may establish a combined airflow having a desired temperature (e.g., based on input from the user interface and/or based on feedback from a temperature sensor within the cab). In addition, the controller may control the cool box output valves such that a portion of the airflow from the cool box exhausts to the external environment and a portion of the airflow from the cool box is recirculated to the blower.

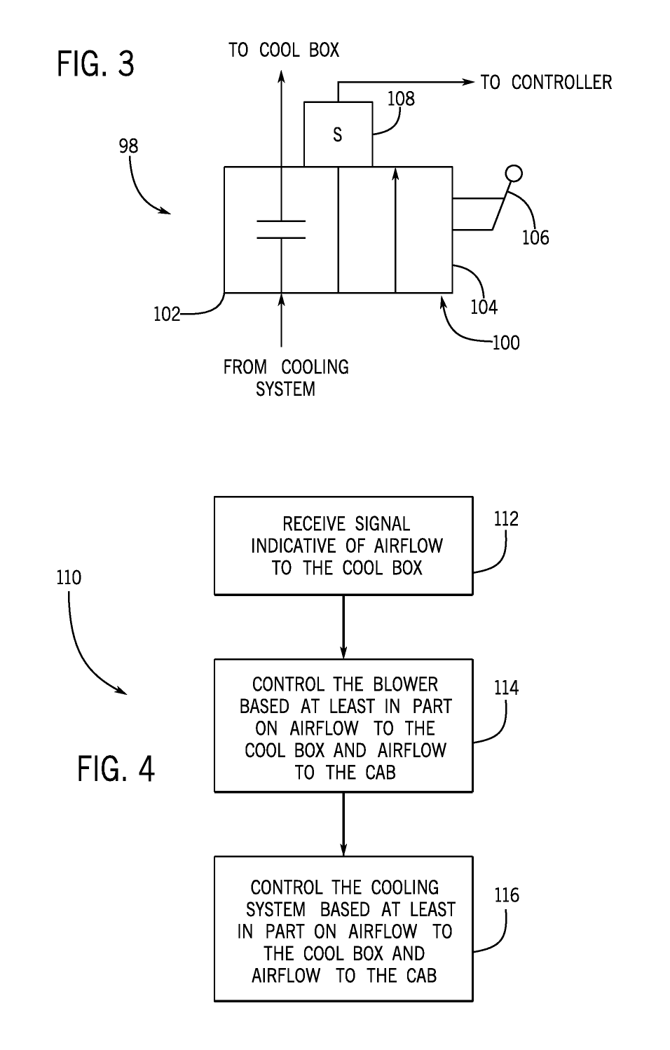

FIG. 3 is a schematic diagram of an embodiment of a valve assembly 98 that may be employed within the airflow control system of FIG. 2. The valve assembly 98 includes a manually controlled valve 100 (e.g., knife valve, shutter valve, etc.) that may replace the cool box input valve in certain embodiments. As illustrated, the manually controlled valve 100 includes a first position 102 configured to block airflow from the cooling system to the cool box, and a second position 104 configured to facilitate airflow from the cooling system to the cool box. In the illustrated embodiment, the valve is controlled (e.g., moved between the first and second positions) via a manually operated level 106. However, it should be appreciated that in alternative embodiments, the valve may be controlled by another manual operator control, such as a plunger or a switch, among other controls. In addition, the valve assembly 98 includes a sensor 108 configured to output a signal to the controller indicative of the position (e.g., state) of the valve 100.

In certain embodiments, the controller is configured to control the blower and/or the cooling system based at least in part on the state of the valve 100. For example, while the sensor 108 outputs a signal indicative of the valve 100 being in the first position 102, the controller may identify the cool box as being deactivated. The controller may adjust the airflow output from the blower and/or the capacity of the cooling system accordingly. For example, while the cool box is deactivated and airflow to the cab is desired, the controller may determine the minimum blower output sufficient to provide the desired airflow to the cab. The controller may then instruct the blower to provide the determined airflow output. In addition, while the cool box is deactivated and chilled airflow to the cab is desired, the controller may determine the minimum cooling system capacity sufficient to provide airflow of a desired temperature to the cab. The controller may then instruct the cooling system to operate at the determined capacity.

In addition, while the sensor 108 outputs a signal indicative of the valve 100 being in the second position 104, the controller may identify the cool box as being activated. The controller may adjust the airflow output from the blower and/or the capacity of the cooling system accordingly. For example, while the cool box is activated and airflow to the cab is desired, the controller may determine the minimum blower output sufficient to provide the desired airflow to the cool box and to the cab. The controller may then instruct the blower to provide the determined airflow output. In addition, while the cool box is activated and chilled airflow to the cab is desired, the controller may determine the minimum cooling system capacity sufficient to provide airflow of a desired temperature to the cool box and to the cab. The controller may then instruct the cooling system to operate at the determined capacity. In certain embodiments, the valve may be a proportional control valve configured to control the airflow into the cool box based on the position (e.g., fully closed, fully open, or partially open) of the valve. In such embodiments, the sensor may be configured to output a signal indicative of the position (e.g., state) of the valve (e.g., valve open percentage).

FIG. 4 is a flow diagram of an embodiment of a method 100 for controlling airflow to the cool box and to the cab of the work vehicle. First, in certain embodiments, a signal indicative of airflow to the cool box is received, as represented by block 112. For example, the controller may receive a signal from the valve position sensor indicative of the state of the valve. The controller may then determine that air is flowing to the cool box while the signal indicates that the valve is in the open position and that air is not flowing to the cool box while the signal indicates that the valve is in the closed position. Furthermore, in embodiments in which the valve is controlled by the controller, the controller may instruct the valve to transition to the open position or the closed position.

Next, as represented by block 114, the blower is controlled based at least in part on the desired airflow to the cab and/or the desired airflow to the cool box. For example, while the cool box input valve is closed (e.g., while the cool box is deactivated) and airflow to the cab is desired, the controller may determine the minimum blower output sufficient to provide the desired airflow to the cab (e.g., based on input from the user interface). The controller may then instruct the blower to provide the determined airflow output. In addition, while the cool box input valve is open (e.g., while the cool box is activated) and no airflow to the cab is desired, the controller may determine the minimum blower output sufficient to provide the desired airflow to the cool box (e.g., based on input from the user interface). The controller may then instruct the blower to provide the determined airflow output. Furthermore, while the cool box input valve is open (e.g., while the cool box is activated) and airflow to the cab is desired, the controller may determine the minimum blower output sufficient to provide the desired airflow to the cab and to the cool box (e.g., based on input from the user interface). The controller may then instruct the blower to provide the determined airflow output.

In addition, as represented by block 116, the capacity of the cooling system is controlled based at least in part on the target temperature of chilled airflow to the cab and/or the target temperature of chilled airflow to the cool box. For example, while the cool box input valve is closed (e.g., while the cool box is deactivated) and chilled airflow to the cab is desired, the controller may determine the minimum cooling system capacity sufficient to provide airflow of a target temperature to the cab (e.g., based on input from the user interface). The controller may then instruct the cooling system to operate at the determined capacity. In addition, while the cool box input valve is open (e.g., while the cool box is activated) and no chilled airflow to the cab is desired, the controller may determine the minimum cooling system capacity sufficient to provide airflow at a target temperature to the cool box (e.g., based on input from the user interface). The controller may then instruct the cooling system to operate at the determined capacity. Furthermore, while the cool box input valve is open (e.g., while the cool box is activated) and chilled airflow to the cab is desired, the controller may determine the minimum cooling system capacity sufficient to provide airflow at a target temperature to the cab and to the cool box (e.g., based on input from the user interface). The controller may then instruct the cooling system to operate at the determined capacity.

While only certain features have been illustrated and described herein, many modifications and changes will occur to those skilled in the art. It is, therefore, to be understood that the appended claims are intended to cover all such modifications and changes as fall within the true spirit of the disclosure.

1. An airflow control system of a work vehicle, comprising:
a cooling system output flow passage configured to receive a cooling system output airflow from a cooling system and to direct the cooling system output airflow toward a cab of the work vehicle;
a cool box input flow passage having a first end fluidly coupled to the cooling system output flow passage and a second end directly fluidly coupled to a cool box, wherein the cool box input flow passage is configured to only receive the cooling system output airflow and to provide only the cooling system output airflow to the cool box;
a cool box input valve fluidly coupled to the cool box input flow passage between the first end and the second end, wherein the cool box input valve is configured to control the cooling system output airflow through the cool box input flow passage; and
a controller communicatively coupled to the cool box input valve, wherein the controller is configured to instruct the cool box input valve to selectively transition to an open position, a closed position, and a position between the open and closed positions to control a temperature within an interior of the cool box.

2. The airflow control system of claim 1, comprising a temperature sensor configured to output a signal indicative of the temperature within the interior of the cool box, wherein the temperature sensor is communicatively coupled to the controller, and the controller is configured to control the cool box input valve based at least in part on the signal.

3. The airflow control system of claim 1, comprising a first cool box output flow passage configured to receive a first cool box output airflow from the cool box and to direct the first cool box output airflow toward the cooling system.

4. The airflow control system of claim 3, comprising:
a second cool box output flow passage configured to receive a second cool box output airflow from the cool box and to direct the second cool box output airflow to an external environment;
a first cool box output valve fluidly coupled to the first cool box output flow passage, wherein the first cool box output valve is configured to control the first cool box output airflow through the first cool box output flow passage; and
a second cool box output valve fluidly coupled to the second cool box output flow passage, wherein the second cool box output valve is configured to control the second cool box output airflow through the second cool box output flow passage.

5. The airflow control system of claim 1, wherein the controller is configured to control a capacity of the cooling system to control the temperature within the interior of the cool box.

6. A heating, ventilation, and air conditioning (HVAC) system of a work vehicle, comprising:
a cool box configured to storage objects;
a cooling system configured to output a cooling system output airflow;
a heating system configured to receive the cooling system output airflow and to generate a heating system output airflow;
a cooling system output flow passage extending between the cooling system and the heating system, wherein the cooling system output flow passage is configured to receive the cooling system output airflow and to provide the cooling system output airflow to the heating system;
a heating system output flow passage configured to receive the heating system output airflow from the heating system and to direct the heating system output airflow toward a cab of the work vehicle;
a cool box input flow passage configured to receive a cool box input airflow from the cooling system and to provide the cool box input airflow to the cool box; and
a controller communicatively coupled to the cooling system and to the heating system, wherein the controller is configured to control a capacity of the heating system based at least in part on a capacity of the cooling system at least while the cooling system is in operation to provide the cool box input airflow to the cool box.

7. The HVAC system of claim 6, comprising a first cool box output flow passage configured to receive a first cool box output airflow from the cool box and to direct the first cool box output airflow toward the cooling system.

8. The HVAC system of claim 7, comprising:
a second cool box output flow passage configured to receive a second cool box output airflow from the cool box and to direct the second cool box output airflow to an external environment;
a first cool box output valve fluidly coupled to the first cool box output flow passage, wherein the first cool box output valve is configured to control the first cool box output airflow through the first cool box output flow passage; and
a second cool box output valve fluidly coupled to the second cool box output flow passage, wherein the second cool box output valve is configured to control the second cool box output airflow through the second cool box output flow passage.

9. The HVAC system of claim 6, wherein the airflow control system comprises a cool box input valve configured to control the cool box input airflow through the cool box input flow passage, the controller is communicatively coupled to the cool box input valve, and the controller is configured to control the cool box input valve to control the cool box input airflow into the cool box.

10. The HVAC system of claim 6, wherein the airflow control system comprises:
a cool box input valve configured to control the cool box input airflow through the cool box input flow passage; and
a sensor configured to output a signal indicative of a state of the cool box input valve;
wherein the controller is communicatively coupled to the sensor, the controller is communicatively coupled to the blower, the cooling system, or a combination thereof, and the controller is configured to control the blower, the cooling system, or a combination thereof, based on the signal.

11. An airflow control system of a work vehicle, comprising:
a cooling system output flow passage configured to receive a cooling system output airflow from a cooling system and to direct the cooling system output airflow toward a cab of the work vehicle;
a cooling system output valve configured to control the cooling system output airflow through the cooling system output flow passage;
a cooling system bypass flow passage configured to receive a cooling system bypass airflow from a blower and to direct the cooling system bypass airflow toward the cab of the work vehicle while bypassing the cooling system;
a cooling system bypass valve configured to control the cooling system bypass airflow through the cooling system bypass flow passage; and
a cool box input flow passage configured to receive a cool box input airflow from the cooling system and to provide the cool box input airflow to a cool box.

12. The airflow control system of claim 11, comprising a cooling system input flow passage configured to receive a cooling system input airflow from the blower and to provide the cooling system input airflow to the cooling system, wherein a first end of the cooling system bypass flow passage is fluidly coupled to the cooling system input flow passage, and a second end of the cooling system bypass flow passage is fluidly coupled to the cooling system output flow passage downstream from the cooling system output valve.

13. The airflow control system of claim 11, wherein a first end of the cool box input flow passage is fluidly coupled to the cooling system output flow passage upstream of the cooling system output valve, and a second end of the cool box input flow passage is fluidly coupled to the cool box.

14. The airflow control system of claim 11, comprising a first cool box output flow passage configured to receive a first cool box output airflow from the cool box and to direct the first cool box output airflow toward the blower.

15. The airflow control system of claim 14, comprising:
a second cool box output flow passage configured to receive a second cool box output airflow from the cool box and to direct the second cool box output airflow to an external environment;
a first cool box output valve fluidly coupled to the first cool box output flow passage, wherein the first cool box output valve is configured to control the first cool box output airflow through the first cool box output flow passage; and
a second cool box output valve fluidly coupled to the second cool box output flow passage, wherein the second cool box output valve is configured to control the second cool box output airflow through the second cool box output flow passage.

16. The airflow system of claim 11, comprising a controller communicatively coupled to the cooling system output valve and to the cooling system bypass valve, wherein the controller is configured to instruct the cooling system output valve to open and the cooling system bypass valve to close to provide the cooling system output airflow to the cab of the work vehicle, and the controller is configured to instruct the cooling system output valve to close and the cooling system bypass valve to open to provide the cooling system bypass airflow to the cab of the work vehicle while bypassing the cooling system.

17. The airflow control system of claim 16, comprising a cool box input valve configured to control the cool box input airflow through the cool box input flow passage, wherein the controller is communicatively coupled to the cool box input valve, and the controller is configured to control the cool box input valve to control the cool box input airflow into the cool box.

18. The airflow control system of claim 16, comprising:
a cool box input valve configured to control the cool box input airflow through the cool box input flow passage; and
a sensor configured to output a signal indicative of a state of the cool box input valve;
wherein the controller is communicatively coupled to the sensor, and the controller is configured to control the blower, the cooling system, or a combination thereof, based on the signal.

19. The airflow control system of claim 16, wherein the controller is configured to control the blower based at least in part on a state of the cooling system output valve, a state of the cooling system bypass valve, or a combination thereof.

20. The airflow control system of claim 16, wherein the controller is configured to control a capacity of the cooling system based at least in part on a state of the cooling system output valve, a state of the cooling system bypass valve, or a combination thereof.
